(19) United States
(12) Patent Application Publication
(10) Pub. No.: US 2023/0222676 A1
(43) Pub. Date: Jul. 13, 2023

(54) IMAGE REGISTRATION PERFORMANCE ASSURANCE

(71) Applicant: International Business Machines Corporation, Armonk, NY (US)

(72) Inventors: Kourosh Jafari-Khouzani, Rego Park, NY (US); Amin Katouzian, Lexington, MA (US); Aly Mohamed, Acton, MA (US); Frederic Commandeur, Paris (FR)

(21) Appl. No.: 17/647,355

(22) Filed: Jan. 7, 2022

(51) Int. Cl. G06T 7/33; G06T 3/00

(52) U.S. Cl. CPC G06T 7/337; G06T 3/0068; G06T 2207/20212; G06T 2207/20081

(57) ABSTRACT

In an approach for image registration performance assurance by optimizing system configurations, a processor evaluates alignment of a registered image and a fixed image using a pre-trained learning model. The registered image is generated with a first registration method. A processor provides a reward score to the alignment, the reward score being defined as a higher score indicating a better alignment. A processor generates a registration status represented as a feature vector that contains information about how the registered and fixed images are aligned. A processor determines a second registration method based on the reward score, the feature vector, and the first registration method.

### BACKGROUND

The present disclosure relates generally to the field of image registration, and more particularly to an artificial intelligence (AI) based system for image registration performance assurance by optimizing system configurations.

Image registration can be a process of transforming different sets of data into one coordinate system. Data may be multiple photographs, data from different sensors, times, depths, or viewpoints. Image registration can be used in computer vision, medical imaging, military automatic target recognition, and compiling and analyzing images and data from satellites. Registration may be necessary in order to be able to compare or integrate the data obtained from these different measurements. Image registration or image alignment algorithms can be classified into intensity-based and feature-based. One of the images may be referred to as the moving or source and the others may be referred to as the target, fixed or sensed images. Image registration may involve spatially transforming the source/moving image(s) to align with the target image. The reference frame in the target image can be stationary, while the other datasets may be transformed to match to the target. Intensity-based methods may compare intensity patterns in images via correlation metrics, while feature-based methods may find correspondence between image features such as points, lines, and contours.

Image registration algorithms can also be classified according to the transformation models they use to relate the target image space to the reference image space. The first broad category of transformation models may include linear transformations, which include rotation, scaling, translation, and other affine transforms. The second category of transformations may allow ‘elastic’ or ‘nonrigid’ transformations. These transformations are capable of locally warping the target image to align with the reference image. Nonrigid transformations may include radial basis functions, physical continuum models, and large deformation models. Transformations may be commonly described by a parametrization, where the model dictates the number of parameters.

### SUMMARY

Aspects of an embodiment of the present disclosure disclose an approach for image registration performance assurance by optimizing system configurations. A processor evaluates alignment of a registered image and a fixed image using a pre-trained learning model. The registered image is generated with a first registration method. A processor provides a reward score to the alignment, the reward score being defined as a higher score indicating a better alignment. A processor generates a registration status represented as a feature vector that contains information about how the registered and fixed images are aligned. A processor determines a second registration method based on the reward score, the feature vector, and the first registration method.

### BRIEF DESCRIPTION OF THE DRAWINGS

FIG. 1 is a functional block diagram illustrating an image registration performance assurance environment, in accordance with an embodiment of the present disclosure.

FIG. 2 is a flowchart depicting operational steps of an optimization module within a computing device of FIG. 1, in accordance with an embodiment of the present disclosure.

FIG. 3 illustrates an exemplary part of functional diagram of the optimization module within the computing device of FIG. 1, in accordance with an embodiment of the present disclosure.

FIG. 4 illustrates another exemplary functional diagram of the optimization module within the computing device of FIG. 1, in accordance with an embodiment of the present disclosure.

FIGS. 5A-5B illustrate an exemplary functional environment of the optimization module within the computing device of FIG. 1, in accordance with an embodiment of the present disclosure.

FIG. 6 illustrates another exemplary functional environment of the optimization module within the computing device of FIG. 1, in accordance with an embodiment of the present disclosure.

FIG. 7 is a block diagram of components of the computing device of FIG. 1, in accordance with an embodiment of the present disclosure.

### DETAILED DESCRIPTION

The present disclosure is directed to systems and methods for image registration performance assurance by optimizing system configurations.

Embodiments of the present disclosure recognize a need for realizing when image registration has failed so that an appropriate action can be taken, e.g., using a better registration method, rejecting the image study. Embodiments of the present disclosure recognize a need for showing the degree of a correct alignment for the image registration. Embodiments of the present disclosure disclose training a deep learning-based classifier to evaluate affine image registration quality and to accept or reject the registration outcome. If the registration outcome is not acceptable, embodiments of the present disclosure disclose proposing to modify the registration algorithm configuration based on various rules and to repeat the process. If the algorithm keeps failing after a number of pre-determined attempts, the registration task may be rejected.

Embodiments of the present disclosure disclose a deep learning model taking a fixed image and a moving image as input and classifying the images into “aligned” or “misaligned”. Embodiments of the present disclosure disclose combining the two images into a single 3-channel RGB image, which can be an input to a deep learning network. In another example, the model can be a model with 2-channel inputs as well. Embodiments of the present disclosure disclose preparing a dataset for training the network with an automated method and a manual method. Embodiments of the present disclosure disclose using reinforcement learning to choose an image registration method. Embodiments of the present disclosure disclose changing the registration configuration (e.g., parameters, settings, cost function) based on the quality of alignment, the spatial relations of the images, and the previous registration method. Embodiments of the present disclosure disclose using deep learning to assess the image registration performance and provide reward. Embodiments of the present disclosure disclose automatically generating training data for the learning model. Embodiments of the present disclosure disclose using deep learning to compare images to help choose an action. Embodiments of the present disclosure disclose combining moving and fixed images into an RGB image as input of a learning model. Embodiments of the present disclosure disclose evaluating the registration performance and outputting a registration quality index as the reward. Embodiments of the present disclosure disclose comparing the images and outputting a feature vector that contains information that helps choosing an action.

Embodiments of the present disclosure disclose systems and methods for aligning images utilizing reinforcement learning to choose a registration method. Embodiments of the present disclosure disclose applying a deep machine learning and a registration selection model to a first image and a second image for image registration. Embodiments of the present disclosure disclose applying registration methods to form combined images. Embodiments of the present disclosure disclose assessing a quality of the combined images to form an assessment. Embodiments of the present disclosure disclose applying a reward reinforcement learning to the assessments. Embodiments of the present disclosure disclose choosing a registration method based on the iterative select maximizing rewards. Embodiments of the present disclosure disclose evaluating registration performance and outputting a registration quality index as a reward. Embodiments of the present disclosure disclose mapping the first image and the second image in the combined image to a feature vector. Embodiments of the present disclosure disclose changing registration configuration data based on rules until a completion criterion is met wherein the completion criteria is one of a successful alignment reached and an attempt threshold is reached. Embodiments of the present disclosure disclose systems and methods that evaluate the result of a registration method with a particular configuration (e.g., a set of optimization hyper-parameters, cost function).

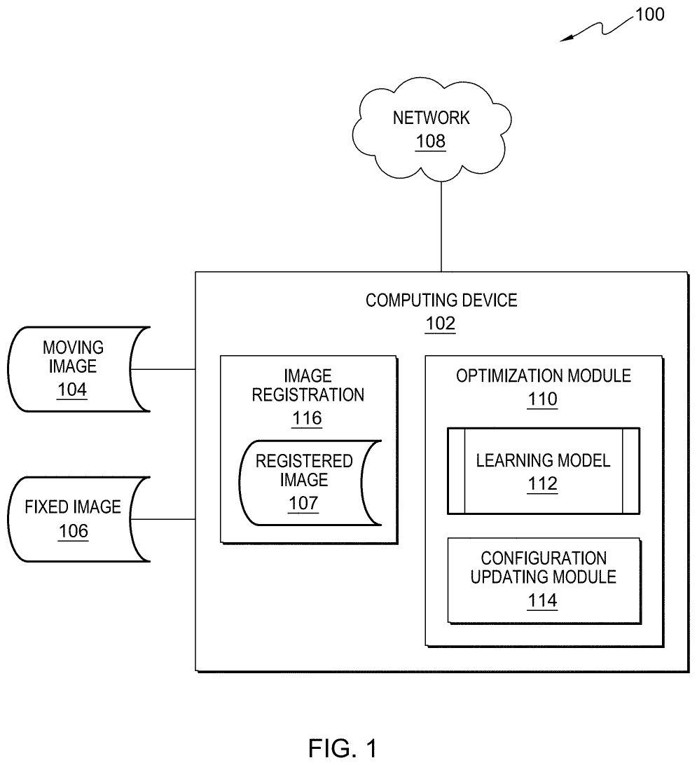

The present disclosure will now be described in detail with reference to the Figures. FIG. 1 is a functional block diagram illustrating an image registration performance assurance environment, generally designated 100, in accordance with an embodiment of the present disclosure.

In the depicted embodiment, image registration performance assurance environment 100 includes computing device 102, moving image 104, fixed image 106, and network 108. Further, in the depicted embodiment, computing device 102 includes image registration 116 and optimization module 110. Image registration 116 may be a process of aligning two or more images (e.g., moving image 104, fixed image 106), which helps with the analysis of corresponding regions in the images. For example, image registration 116 can be the process of transforming different sets of data into one coordinate system. Data may be multiple photographs, data from different sensors, times, depths, or viewpoints. Registration may be necessary to be able to compare or integrate the data obtained from these different measurements. Image registration or image alignment algorithms can be classified into intensity-based and feature-based. One of the images is referred to as the moving or source (e.g., moving image 104) and the others may be referred to as the target, fixed or sensed images (e.g., fixed image 106). Image registration 116 may involve spatially transforming moving image 104 to align with fixed image 106. The reference frame in fixed image 106 may be stationary, while the other datasets (e.g., moving image 104) may be transformed to match to fixed image 106. Intensity-based methods may compare intensity patterns in images via correlation metrics, while feature-based methods may find correspondence between image features such as points, lines, and contours. Intensity-based methods may register entire images or sub-images. If sub-images are registered, centers of corresponding sub images are treated as corresponding feature points. Feature-based methods may establish a correspondence between a number of especially distinct points in images.

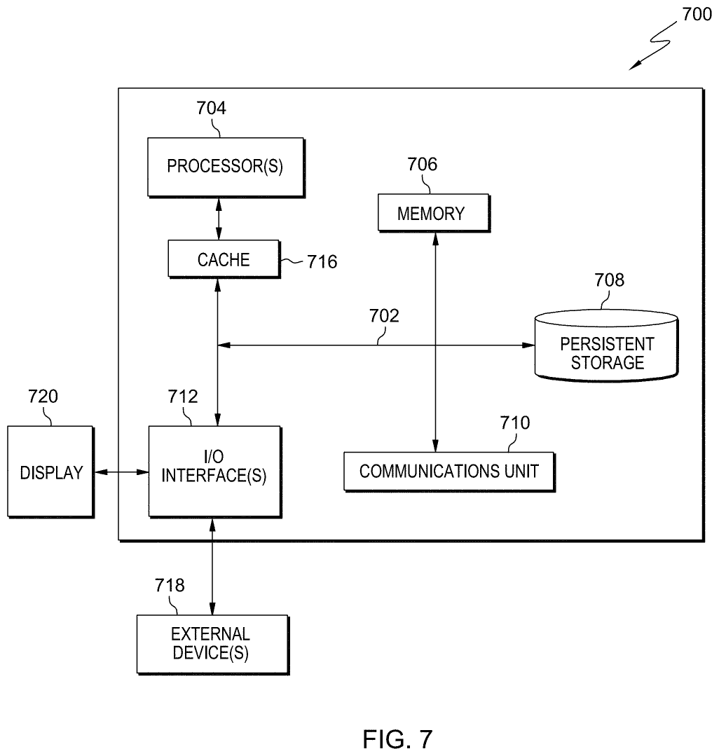

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to optimization module 110 and network 108 and is capable of processing program instructions and executing optimization module 110, in accordance with an embodiment of the present disclosure. Computing device 102 may include internal and external hardware components, as depicted and described in further detail with respect to FIG. 7.

Further, in the depicted embodiment, computing device 102 includes image registration 116 and optimization module 110. In the depicted embodiment, image registration 116 and optimization module 110 are located on computing device 102. However, in other embodiments, image registration 116 and optimization module 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and image registration 116 and optimization module 110, in accordance with a desired embodiment of the disclosure.

In one or more embodiments, image registration 116 is configured to align moving image 104 and fixed image 106. Moving image 104 can be a source image. Fixed image 106 can be a target image. Image registration 116 may generate registered image 107 based on moving image 104 and fixed image 106 for the alignment of moving image 104 and fixed image 106. Image registration 116 may be a process of aligning two or more images (e.g., moving image 104, fixed image 106), which helps with the analysis of corresponding regions in the images. For example, image registration 116 can be the process of transforming different sets of data into one coordinate system. Data may be multiple photographs, data from different sensors, times, depths, or viewpoints. Registration may be necessary to be able to compare or integrate the data obtained from these different measurements. Image registration or image alignment algorithms can be classified into intensity-based and feature-based. One of the images is referred to as the moving or source (e.g., moving image 104) and the others may be referred to as the target, fixed or sensed images (e.g., fixed image 106). Image registration 116 may involve spatially transforming moving image 104 to align with fixed image 106. The reference frame in fixed image 106 may be stationary, while the other datasets (e.g., moving image 104) may be transformed to match to fixed image 106. Intensity-based methods may compare intensity patterns in images via correlation metrics, while feature-based methods may find correspondence between image features such as points, lines, and contours. Intensity-based methods may register entire images or sub-images. If sub-images are registered, centers of corresponding sub images are treated as corresponding feature points. Feature-based methods may establish a correspondence between a number of especially distinct points in images. In some examples, registration metrics such as mutual information, correlation coefficient, mean square error, etc. may measure the alignment between images 104, 106.

In the depicted embodiment, optimization module 110 includes learning model 112 and configuration updating module 114. In the depicted embodiment, learning model 112 and configuration updating module 114 are located on optimization module 110 and computing device 102. However, in other embodiments, learning model 112 and configuration updating module 114 may be located externally and accessed through a communication network such as network 108.

In one or more embodiments, optimization module 110 is configured to evaluate alignment of registered image 107 and fixed image 106 by using learning model 112. Registered image 107 can be generated with a registration method or algorithm by image registration 116. In an example, learning model 112 can be a pre-trained deep learning model to evaluate how well registered image 107 and fixed image 106 are aligned. Learning model 112 may provide a score as “reward” based on the alignment of registered image 107 and fixed image 106. Learning model 112 may compare registered image 107 and fixed image 106 to help decide what to do next. In an example, learning model 112 may classify a pair of images into “aligned” and “misaligned”. In another example, learning model 112 may generate a continuous “registration quality index”. Optimization module 110 may provide inputs to learning model 112 by combining fixed image 106 and registered image 107 into one red-green-blue (RGB) image. Learning model 112 may compare corresponding regions spatially in fixed image 106 and registered image 107. In an example, optimization module 110 may provide inputs to learning model 112 by combining any two of moving image 104, fixed image 106 and registered image 107 into one RGB image. Optimization module 110 may automatically generate training data for learning model 112. Optimization module 110 may generate data samples for learning model 112 as a binary classifier, e.g., aligned or misaligned images. For example, optimization module 110 may register diffusion-weighted imaging (DWI) to T2-weighted (T2w) images for aligned images as training data. Optimization module 110 may randomly change the transformation and resample the training data for misaligned images. Optimization module 110 may result in noisy labels and can learn from noisy labels. Optimization module 110 may generate a “distance” between the noisy and original transformation as data samples for the registration quality index for learning model 112. In another example, optimization module 110 may take inputs from visually assessing registration results and categories for learning model 112.

In an example, optimization module 110 may train and use learning model 112 to evaluate affine image registration quality and to accept or reject the registration outcome. If the registration outcome is rejected, optimization module 110 may modify the registration algorithm configuration in image registration 116 based on pre-defined rules and may repeat the process. If the algorithm keeps failing after a number of attempts, optimization module 110 may reject the registration task. Optimization module 110 may assess the registration outcome. Depending on the outcome, optimization module 110 may either accept the outcome or suggest a change in the configuration to improve the result. Optimization module 110 may apply learning model 112 iteratively to registered image 107 and fixed image 106. Optimization module 110 may apply image registration models to form combined images of registered image 107 and fixed image 106. Optimization module 110 may assess quality of the combined image to form an assessment. In an example, at least one of the combined images is an RGB image.

In an example, optimization module 110 may take two images (e.g., registered image 107 and fixed image 106) as input and may classify the images into “aligned” or “misaligned” by learning model 112. Registered image 107 and fixed image 106 may have the same size. Optimization module 110 may combine registered image 107 and fixed image 106 into a single 3-channel RGB image, which can be an input to learning model 112. This combination can be done in different ways. Any other combination that has the two fixed and moving images is fine, for example, including 2-channel inputs. In an example, optimization module 110 can have 2-channel or 3-channel inputs, or even more generally n-channel inputs if the images to register are multi-channel data. For example, if the fixed image is 1-channel and the moving image is 3-channel, then one can use a 4-channel input for the assessment of registration quality. In another example, optimization module 110 can have any combination of these (e.g., for the above example a 3-channel input with one channel from the fixed image and 2 channels from the moving image, or a 2-channel input with one channel from the fixed image and one channel from the moving image).

In another example, to prepare a dataset for training learning model 112, optimization module 110 may have two methods: automated method and manual method. In the automated method, optimization module 110 may optimize the configuration of a standard registration method for a specific registration task and may assume that the registration outcome is fine. Optimization module 110 may pick a pair of images, e.g., fixed image 106 and moving image 104, from the dataset, may register the images and may combine each pair of slices from the two registered images to generate samples for the “aligned” class. Optimization module 110 may add noise to the transformation matrix and may apply the transformation to moving image 104 and resample the training data. Optimization module 110 may combine the resulting image and the fixed image to generate a “misaligned” input sample. This method of generating training samples may result in noisy labels. This is fine as long as optimization module 110 can have enough samples and the majority of samples have correct labels, since learning model 112 can still learn from noisy labels. In the manual method, optimization module 110 may suggest a manual and visual check of the result of registration and may assign an appropriate label to a data sample.

In one or more embodiments, optimization module 110 is configured to provide a reward score to the alignment of registered image 107 and fixed image 106 by applying learning model 112. In an example, the reward score can be defined as a higher score indicating a better alignment for the image. The range of the reward score can be between 0 and 1 with “0” as the least or no alignment and “1” as the highest alignment. Optimization module 110 may output a registration quality index as a reward. Optimization module 110 may use reinforcement learning to choose a registration method for moving image 104 in image registration 116 to generate registered image 107. Optimization module 110 may combine moving image 104 and fixed image 106 into one RGB image as input of learning model 112. Optimization module 110 may evaluate the registration performance and may output a registration quality index as the reward. Optimization module 110 may compare the images and may output a feature vector that contains information that helps configuration updating module 114 choose an action. Optimization module 110 may use learning model 112 to provide the reward for the reinforcement learning by judging the registration quality from the images. Generally, reinforcement learning is an area of machine learning concerned with how intelligent agents ought to take actions in an environment in order to maximize the notion of cumulative reward. Reinforcement learning may be one of three basic machine learning paradigms, alongside supervised learning and unsupervised learning. Reinforcement learning may differ from supervised learning in not needing labelled input/output pairs be presented, and in not needing sub-optimal actions to be explicitly corrected. Instead, the focus is on finding a balance between exploration (of uncharted territory) and exploitation (of current knowledge). In an example, optimization module 110 may train learning model 112 in various methods. In the inference time, optimization module 110 may run learning model 112 on each pair of slices from the two images and apply majority voting to all the network (e.g., learning model 112) outputs. Optimization module 110 may also compare the images in 3D instead of comparing each of the slice pairs in 2D. If learning model 112 classifies a pair of images to “misaligned”, then optimization module 110 may take an appropriate action using a rule-based method to improve the registration result.

In one or more embodiments, optimization module 110 is configured to generate a registration status represented as a feature vector that contains information about how registered image 107 and fixed image 106 are aligned. Optimization module 110 may apply a reward reinforcement learning to the assessment of the alignment of registered image 107 and fixed image 106. Optimization module 110 may map registered image 107 and fixed image 106 in the combined image to the feature vector. Optimization module 110 may compare registered image 107 and fixed image 106 and may generate the registration status represented as the feature vector that may contain information about how off the images are, how noisy the images are, what modality the images are, etc. Optimization module 110 may evaluate the result of a registration method with a particular configuration (e.g., a set of optimization hyper-parameters, cost function, etc.) and may find out if the result is good enough and if it is not, what other method/configuration can make it better. Optimization module 110 may suggest what optimization method (along with other components of a registration algorithm) may result in a good registration. Optimization module 110 may perform an agent action with the use of a different registration algorithm with different configuration and hyperparameters. Optimization module 110 may propose an agent-based approach to select the best registration method.

In one or more embodiments, optimization module 110 is configured to determine a second registration method, based on the reward score and the feature vector, for registered image 107. Optimization module 110 may compare the first registration method to the second registration method based on the reward score and the feature vector for the alignment of registered image 107 and fixed image 106 based on the registration methods in image registration 116. Optimization module 110 may choose a selected model based on the iterative select maximizing rewards. Optimization module 110 may change registration configuration data based on rules until completion criteria are met. Optimization module 110 may determine a second registration method when the completion criteria is one of a successful alignment reached and an attempt threshold is reached. In an example, the changing registration configuration data may be selected from a group consisting of a cost function, an optimization method, an initial transformation, a multi-resolution registration, a registration mask, hyper-parameters (e.g., percentage of sample points used for registration, optimization parameters).

In an example, if optimization module 110 determines the probability of alignment is low (e.g., meaning large shift between the images), optimization module 110 may choose a different initialization method. For example, if optimization module 110 determines any input image is noisy, optimization module 110 may use a higher number of sample points. If optimization module 110 determines the images are from the same modality, optimization module 110 may try correlation coefficient cost function. Otherwise, optimization module 110 may just try a different cost function. Optimization module 110 may modify the optimization parameters (learning rate, etc.). Optimization module 110 may try multi-resolution registration. Optimization module 110 may use a registration mask or change the mask if the mask is already used. If optimization module 110 determines that the registration outcome is classified as aligned, optimization module 110 may stop and return the registration parameters. If optimization module 110 has tried different registration configurations for a number of times and the outcome is still classified as misaligned, optimization module 110 may stop and return a failure notice.

In one or more embodiments, learning model 112 is configured to evaluate how well registered image 107 and fixed image 106 are aligned. Learning model 112 may provide a score as “reward” based on the alignment of registered image 107 and fixed image 106. Learning model 112 may compare registered image 107 and fixed image 106 to help decide what to do next. In an example, learning model 112 may classify a pair of images into “aligned” and “misaligned”. In another example, learning model 112 may generate a continuous “registration quality index”. Learning model 112 may combine fixed image 106 and registered image 107 into one RGB image as an input. Learning model 112 may compare corresponding regions spatially in fixed image 106 and registered image 107. Learning model 112 may combine any two of moving image 104, fixed image 106 and registered image 107 into one RGB image. Other suitable combination of the images for an RGB image is possible. Learning model 112 may receive training data automatically generated. Learning model 112 may receive data samples for training as a binary classifier, e.g., aligned or misaligned images. For example, optimization module 110 may register DWI to T2 W images for aligned images as training data. Data samples for training learning model 112 can be randomly changed with specified transformations and may be resampled for misaligned images. Data samples can be resulted in noisy labels and can learn from noisy labels. Data samples can be generated with a “distance” between the noisy and original transformation as data samples for the registration quality index for learning model 112. In another example, optimization module 110 may take inputs from visually assessing registration results and categories for learning model 112. In an example, learning model 112 may evaluate affine image registration quality and may accept or reject the registration outcome. If the registration outcome is rejected, learning model 112 may modify the registration algorithm configuration in image registration 116 based on pre-defined rules and may repeat the process. If the algorithm keeps failing after a number of attempts, learning model 112 may reject the registration task. Optimization module 110 may assess the registration outcome. Depending on the outcome, optimization module 110 may either accept the outcome or suggest a change in the configuration to improve the result. Optimization module 110 may apply learning model 112 iteratively to registered image 107 and fixed image 106. Optimization module 110 may apply image registration models to form combined images of registered image 107 and fixed image 106. Optimization module 110 may assess quality of the combined image to form an assessment.

In one or more embodiments, configuration updating module 114 is configured to use reinforcement learning to choose a registration method. Configuration updating module 114 may change the registration configuration (e.g., parameters, settings, cost function) based on the quality of alignment, the spatial relations of the images, and the previous registration method applied. For example, in a classical registration approach, configuration updating module 114 may provide a set of optimized configurations. Configuration updating module 114 may start with a set of non-optimized configuration. Configuration updating module 114 may eventually find an optimized configuration that could vary from one case to another. Configuration updating module 114 may compare the pair of images using learning model 112. Configuration updating module 114 may evaluate how the images are aligned. Configuration updating module 114 may output a feature vector that contains information about how off the images are, how noisy they are, etc. Based on the feature vector and the current registration method and parameters, configuration updating module 114 may decide what registration method and parameters configuration updating module 114 should try next. In an example, configuration updating module 114 may change a registration method from image registration 116. Configuration updating module 114 may change cost function. Configuration updating module 114 may change an optimization method. Configuration updating module 114 may change the method for generating initial transformation. Configuration updating module 114 may apply multi-resolution registration. Configuration updating module 114 may use a registration mask. Configuration updating module 114 may change hyper-parameters. Configuration updating module 114 may change percentage of sample points used for the registration. Configuration updating module 114 may change optimization parameters (learning rate, etc.). For example, if configuration updating module 114 determines the images are initially too off, configuration updating module 114 may choose a different initialization method. If configuration updating module 114 determines the images are too off after registration, configuration updating module 114 may modify the optimization parameters (learning rate, etc.). If configuration updating module 114 determines the images become better but not satisfactory result after a change, configuration updating module 114 may keep the change and try changing something else. If configuration updating module 114 determines noisy images, configuration updating module 114 may increase the number of sample points. If configuration updating module 114 determines the images from a same modality, configuration updating module 114 may try correlation coefficient cost function. Configuration updating module 114 may determine multi-resolution registration may be good in certain conditions. Configuration updating module 114 may change the registration mask for certain applications. For example, if the mask is too small, then configuration updating module 114 may try dilating the mask. Configuration updating module 114 may use reinforcement learning to make a decision. Configuration updating module 114 may rely on the registration outcome and spatially compare the images.

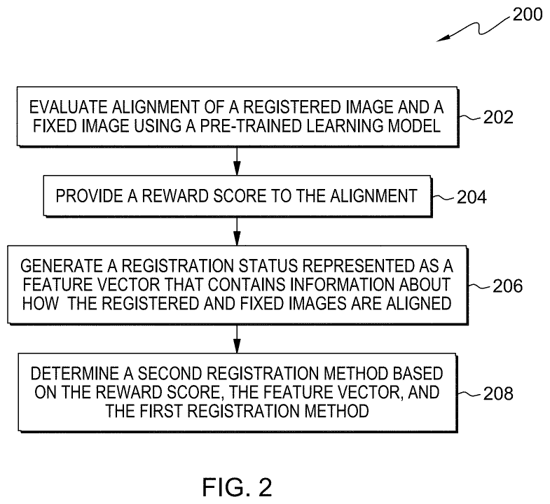

FIG. 2 is a flowchart 200 depicting operational steps of optimization module 110 in accordance with an embodiment of the present disclosure.

Optimization module 110 operates to evaluate alignment of registered image 107 and fixed image 106 by using learning model 112. Registered image 107 can be generated with a registration method or algorithm by image registration 116. Optimization module 110 also operates to provide a reward score to the alignment of registered image 107 and fixed image 106 by applying learning model 112. Optimization module 110 operates to generate a registration status represented as a feature vector that contains information about how registered image 107 and fixed image 106 are aligned. Optimization module 110 operates to determine a second registration method, based on the reward score and the feature vector, for registered image 107.

In step 202, optimization module 110 evaluates alignment of registered image 107 and fixed image 106 by using learning model 112. Registered image 107 can be generated with a registration method or algorithm by image registration 116. In an example, learning model 112 can be a pre-trained deep learning model to evaluate how well registered image 107 and fixed image 106 are aligned. Learning model 112 may provide a score as “reward” based on the alignment of registered image 107 and fixed image 106. Learning model 112 may compare registered image 107 and fixed image 106 to help decide what to do next. In an example, learning model 112 may classify a pair of images into “aligned” and “misaligned”. In another example, learning model 112 may generate a continuous “registration quality index”. Optimization module 110 may provide inputs to learning model 112 by combining fixed image 106 and registered image 107 into one red-green-blue (RGB) image. Learning model 112 may compare corresponding regions spatially in fixed image 106 and registered image 107. In an example, optimization module 110 may provide inputs to learning model 112 by combining any two of moving image 104, fixed image 106 and registered image 107 into one RGB image. Optimization module 110 may automatically generate training data for learning model 112. Optimization module 110 may generate data samples for learning model 112 as a binary classifier, e.g., aligned or misaligned images. For example, optimization module 110 may register diffusion-weighted imaging (DWI) to T2-weighted (T2w) images for aligned images as training data. Optimization module 110 may randomly change the transformation and resample the training data for misaligned images. Optimization module 110 may result in noisy labels and can learn from noisy labels. Optimization module 110 may generate a “distance” between the noisy and original transformation as data samples for the registration quality index for learning model 112. In another example, optimization module 110 may take inputs from visually assessing registration results and categories for learning model 112.

In an example, optimization module 110 may train and use learning model 112 to evaluate affine image registration quality and to accept or reject the registration outcome. If the registration outcome is rejected, optimization module 110 may modify the registration algorithm configuration in image registration 116 based on pre-defined rules and may repeat the process. If the algorithm keeps failing after a number of attempts, optimization module 110 may reject the registration task. Optimization module 110 may assess the registration outcome. Depending on the outcome, optimization module 110 may either accept the outcome or suggest a change in the configuration to improve the result. Optimization module 110 may apply learning model 112 iteratively to registered image 107 and fixed image 106. Optimization module 110 may apply image registration models to form combined images of registered image 107 and fixed image 106. Optimization module 110 may assess quality of the combined image to form an assessment. In an example, at least one of the combined images is an RGB image.

In an example, optimization module 110 may take two images (e.g., registered image 107 and fixed image 106) as input and may classify the images into “aligned” or “misaligned” by learning model 112. Registered image 107 and fixed image 106 may have the same size. Optimization module 110 may combine registered image 107 and fixed image 106 into a single 3-channel RGB image, which can be an input to learning model 112. This combination can be done in different ways. Any other combination that has the two fixed and moving images is fine.

In another example, to prepare a dataset for training learning model 112, optimization module 110 may have two methods: automated method and manual method. In the automated method, optimization module 110 may optimize the configuration of a standard registration method for a specific registration task and may assume that the registration outcome is fine. Optimization module 110 may pick a pair of images, e.g., fixed image 106 and moving image 104, from the dataset, may register the images and may combine each pair of slices from the two registered images to generate samples for the “aligned” class. Optimization module 110 may add noise to the transformation matrix and may apply the transformation to moving image 104 and resample the training data. Optimization module 110 may combine the resulting image and the fixed image to generate a “misaligned” input sample. This method of generating training samples may result in noisy labels. This is fine as long as optimization module 110 can have enough samples and the majority of samples have correct labels, since learning model 112 can still learn from noisy labels. In the manual method, a human being may visually check the result of registration and may assign an appropriate label to a data sample. Optimization module 110 may use that data.

In step 204, optimization module 110 provides a reward score to the alignment of registered image 107 and fixed image 106 by applying learning model 112. In an example, the reward score can be defined as a higher score indicating a better alignment for the image. The range of the reward score can be between 0 and 1 with “0” as the least or no alignment and “1” as the highest alignment. Optimization module 110 may output a registration quality index as a reward. Optimization module 110 may use reinforcement learning to choose a registration method for moving image 104 in image registration 116 to generate registered image 107. Optimization module 110 may combine moving image 104 and fixed image 106 into one RGB image as input of learning model 112. Optimization module 110 may evaluate the registration performance and may output a registration quality index as the reward. Optimization module 110 may compare the images and may output a feature vector that contains information that helps configuration updating module 114 choose an action. Optimization module 110 may use learning model 112 to provide the reward for the reinforcement learning by judging the registration quality from the images. Generally, reinforcement learning is an area of machine learning concerned with how intelligent agents ought to take actions in an environment in order to maximize the notion of cumulative reward. Reinforcement learning may be one of three basic machine learning paradigms, alongside supervised learning and unsupervised learning. Reinforcement learning may differ from supervised learning in not needing labelled input/output pairs be presented, and in not needing sub-optimal actions to be explicitly corrected. Instead, the focus is on finding a balance between exploration (of uncharted territory) and exploitation (of current knowledge). In an example, optimization module 110 may train learning model 112 in various methods. In the inference time, optimization module 110 may run learning model 112 on each pair of slices from the two images and apply majority voting to all the network (e.g., learning model 112) outputs. If learning model 112 classifies a pair of images to “misaligned”, then optimization module 110 may take an appropriate action using a rule-based method to improve the registration result.

In step 206, optimization module 110 generates a registration status represented as a feature vector that contains information about how registered image 107 and fixed image 106 are aligned. Optimization module 110 may apply a reward reinforcement learning to the assessment of the alignment of registered image 107 and fixed image 106. Optimization module 110 may map registered image 107 and fixed image 106 in the combined image to the feature vector. Optimization module 110 may compare registered image 107 and fixed image 106 and may generate the registration status represented as the feature vector that may contain information about how off the images are, how noisy the images are, what modality the images are, etc. Optimization module 110 may evaluate the result of a registration method with a particular configuration (e.g., a set of optimization hyper-parameters, cost function, etc.) and may find out if the result is good enough and if it is not, what other method/configuration can make it better. Optimization module 110 may suggest what optimization method (along with other components of a registration algorithm) may result in a good registration. Optimization module 110 may perform an agent action with the use of a different registration algorithm with different configuration and hyperparameters. Optimization module 110 may propose an agent-based approach to select the best registration method.

In step 208, optimization module 110 determines a second registration method, based on the reward score and the feature vector, for registered image 107. Optimization module 110 may compare the first registration method to the second registration method based on the reward score and the feature vector for the alignment of registered image 107 and fixed image 106 based on the registration methods in image registration 116. Optimization module 110 may choose a selected model based on the iterative select maximizing rewards. Optimization module 110 may change registration configuration data based on rules until completion criteria are met. Optimization module 110 may determine a second registration method when the completion criteria is one of a successful alignment reached and an attempt threshold is reached. In an example, the changing registration configuration data may be selected from a group consisting of a cost function, an optimization method, an initial transformation, a multi-resolution registration, a registration mask, hyper-parameters (e.g., percentage of sample points used for registration, optimization parameters).

In an example, if optimization module 110 determines the probability of alignment is low (e.g., meaning large shift between the images), optimization module 110 may choose a different initialization method. If optimization module 110 determines any input image is noisy, optimization module 110 may use a higher number of sample points. If optimization module 110 determines the images are from the same modality, optimization module 110 may try correlation coefficient cost function. Otherwise, optimization module 110 may just try a different cost function. Optimization module 110 may modify the optimization parameters (learning rate, etc.). Optimization module 110 may try multi-resolution registration. Optimization module 110 may use a registration mask or change the mask if the mask is already used. If optimization module 110 determines that the registration outcome is classified as aligned, optimization module 110 may stop and return the registration parameters. If optimization module 110 has tried different registration configurations for a number of times and the outcome is still classified as misaligned, optimization module 110 may stop and return a failure notice.

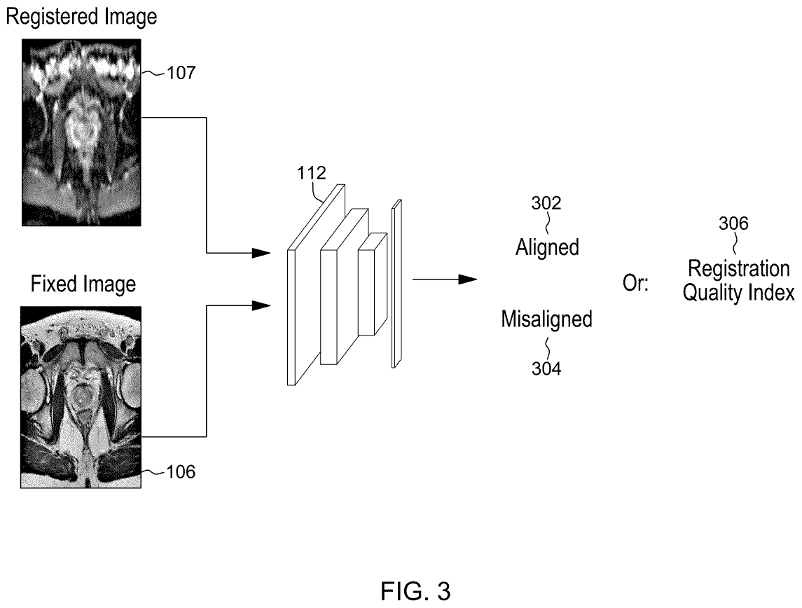

FIG. 3 illustrates an exemplary part of functional diagram of optimization module 110, in accordance with an embodiment of the present disclosure.

In the example of FIG. 3, learning model 112 may compare registered image 107 and fixed image 106 to help decide what to do next. In an example, learning model 112 may classify the pair of registered image 107 and fixed image 106 into “aligned” 302 or “misaligned” 304. In another example, learning model 112 may generate registration quality index 306. Optimization module 110 may output registration quality index 306 as a reward. In an example, the reward score can be defined as a higher score indicating a better alignment for the image. The range of the reward score can be between 0 and 1 with “0” as the least or no alignment and “1” as the highest alignment.

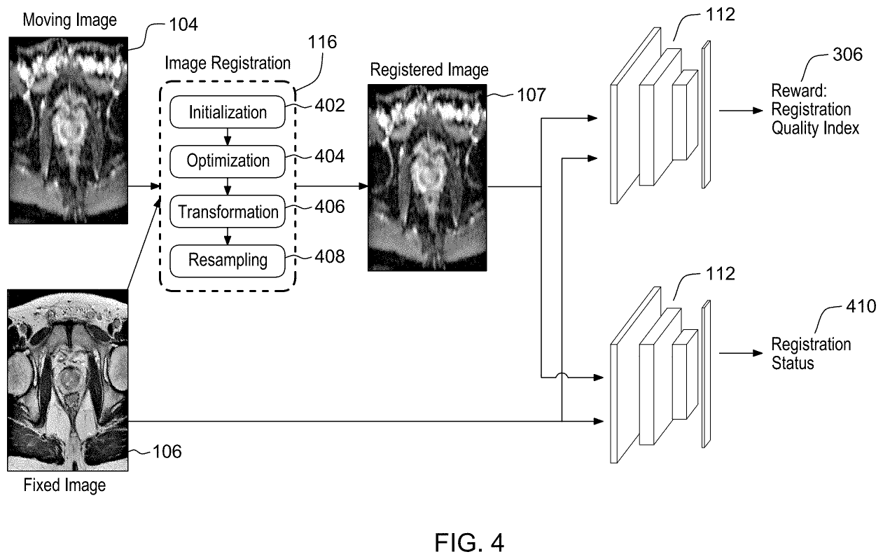

FIG. 4 illustrates an exemplary functional diagram of optimization module 110, in accordance with an embodiment of the present disclosure.

In the example of FIG. 4, image registration 116 may align moving image 104 and fixed image 106. Moving image 104 can be a source image. Fixed image 106 can be a target image. Image registration 116 may generate registered image 107 based on moving image 104 and fixed image 106 for the alignment of moving image 104 and fixed image 106. Image registration 116 may be a process of aligning two or more images (e.g., moving image 104, fixed image 106), which helps with the analysis of corresponding regions in the images. For example, image registration 116 can be the process of transforming different sets of data into one coordinate system. In the depicted embodiment, image registration 116 includes initialization 402, optimization 404, transformation 406, and resampling 408. Learning model 112 may compare registered image 107 and fixed image 106 to help decide what to do next. In an example, learning model 112 may generate registration quality index 306. Optimization module 110 may output registration quality index 306 as a reward. In another example, learning model 112 may generate registration status 410 that can be represented as a feature vector. The feature vector may contain information about how registered image 107 and fixed image 106 are aligned. The feature vector may contain information about how off the images are, how noisy the images are, what modality the images are, etc.

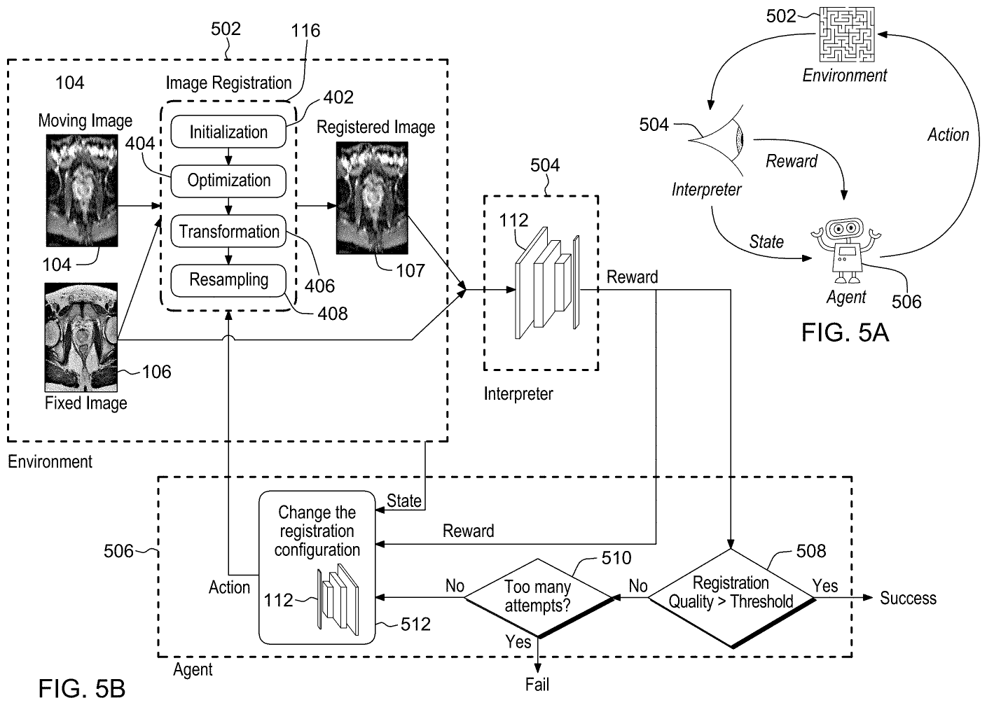

FIGS. 5A-5B illustrate an exemplary functional environment of optimization module 110, in accordance with an embodiment of the present disclosure.

In the example of FIGS. 5A-5B, environment 502 includes moving image 104, fixed image 106, image registration 116, and registered image 107. Interpreter 504 may include learning model 112. Agent 506 may include Configuration updating module 114. Image registration 116 may align moving image 104 and fixed image 106. Image registration 116 may generate registered image 107 based on moving image 104 and fixed image 106 for the alignment of moving image 104 and fixed image 106. Image registration 116 may include initialization 402, optimization 404, transformation 406, and resampling 408. Learning model 112 may evaluate how well registered image 107 and fixed image 106 are aligned. Learning model 112 may provide a score as “reward” based on the alignment of registered image 107 and fixed image 106. Learning model 112 may generate a continuous “registration quality index”. In block 508, optimization module 110 may determine whether a registration quality is above a pre-defined threshold. If optimization module 110 determines that the registration quality is above a pre-defined threshold, optimization module 110 may indicate a success of the alignment of registered image 107. If optimization module 110 determines that the registration quality is not above a pre-defined threshold, in block 510, optimization module 110 may determine whether a number of attempts is more than a pre-defined number. If optimization module 110 determines that a number of attempts is more than a pre-defined number, optimization module 110 may indicate a failure of the alignment of registered image 107 and may reject registered image 107. If optimization module 110 determines that a number of attempts is not more than a pre-defined number, in block 512, optimization module 110 may continue to change the registration configuration. Optimization module 110 may use reinforcement learning to choose a registration method. In the example, agent 506 (e.g., configuration updating module 114) may change the registration configuration (e.g., parameters, settings, cost function) based on the quality of alignment, the spatial relations of the images, and the previous registration method applied. Configuration updating module 114 may compare the pair of images using learning model 112. Optimization module 110 may compare registered image 107 and fixed image 106 and may generate the registration status represented as the feature vector that may contain information about how off the images are, how noisy the images are, what modality the images are, etc. Optimization module 110 may evaluate the result of a registration method with a particular configuration (e.g., a set of optimization hyper-parameters, cost function, etc.) and may find out if the result is good enough and if it is not, what other method/configuration can make it better. Optimization module 110 may suggest what optimization method (along with other components of a registration algorithm) may result in a good registration. Optimization module 110 may perform an agent action with the use of a different registration algorithm with different configuration and hyperparameters. Optimization module 110 may propose an agent-based approach to select the best registration method. The “state” that the agent looks at in order to make a decision is the combination of all information about the registration, including fixed image, moving image, registered image, the registration method and its parameters, and what have previously been tried. The agent may use additional deep learning modules (other than the one used for checking the quality of registration) to make a decision about the next steps.

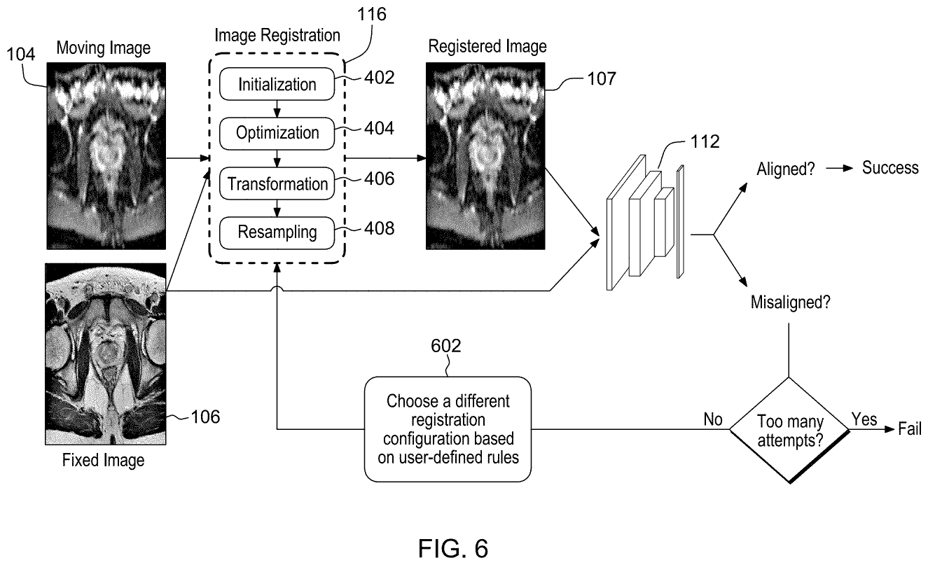

FIG. 6 illustrates another exemplary functional environment of optimization module 110, in accordance with an embodiment of the present disclosure.

In the example of FIG. 6, learning model 112 may determine whether registered image 107 and fixed image 106 are aligned or misaligned. If learning model 112 determines that registered image 107 and fixed image 106 are aligned, optimization module 110 may indicate a success of the alignment of registered image 107. If optimization module 110 determines that registered image 107 and fixed image 106 are misaligned, optimization module 110 may determine whether a number of attempts is more than a pre-defined number. If optimization module 110 determines that a number of attempts is more than a pre-defined number, optimization module 110 indicates a failure of the alignment of registered image 107 and may reject registered image 107. If optimization module 110 determines that a number of attempts is not more than a pre-defined number, in block 602, optimization module 110 may choose a different registration configuration based on user-defined rules.

FIG. 7 depicts a block diagram 700 of components of computing device 102 in accordance with an illustrative embodiment of the present disclosure. It should be appreciated that FIG. 7 provides only an illustration of one implementation and does not imply any limitations with regard to the environments in which different embodiments may be implemented. Many modifications to the depicted environment may be made.

Computing device 102 may include communications fabric 702, which provides communications between cache 716, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses or a crossbar switch.

Memory 706 and persistent storage 708 are computer readable storage media. In this embodiment, memory 706 includes random access memory (RAM). In general, memory 706 can include any suitable volatile or non-volatile computer readable storage media. Cache 716 is a fast memory that enhances the performance of computer processor(s) 704 by holding recently accessed data, and data near accessed data, from memory 706.

Optimization module 110 may be stored in persistent storage 708 and in memory 706 for execution by one or more of the respective computer processors 704 via cache 716. In an embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. Optimization module 110 may be downloaded to persistent storage 708 through communications unit 710.

I/O interface(s) 712 allows for input and output of data with other devices that may be connected to computing device 102. For example, I/O interface 712 may provide a connection to external devices 718 such as a keyboard, keypad, a touch screen, and/or some other suitable input device. External devices 718 can also include portable computer readable storage media such as, for example, thumb drives, portable optical or magnetic disks, and memory cards. Software and data used to practice embodiments of the present invention, e.g., optimization module 110 can be stored on such portable computer readable storage media and can be loaded onto persistent storage 708 via I/O interface(s) 712. I/O interface(s) 712 also connect to display 720.

Display 720 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
evaluating, by one or more processors, alignment of a registered image and a fixed image using a pre-trained learning model, the registered image generated with a first registration method;
providing, by one or more processors, a reward score to the alignment, the reward score being defined as a higher score indicating a better alignment;
generating, by one or more processors, a registration status represented as a feature vector that contains information about how the registered and fixed images are aligned; and
determining, by one or more processors, a second registration method based on the reward score, the feature vector, and the first registration method.

2. The computer-implemented method of claim 1, further comprising:
combining the registered image and the fixed image into a red-green-blue (RGB) image.

3. The computer-implemented method of claim 1, further comprising:
classifying the registered image and the fixed image into being misaligned; and
using reinforcement learning to choose the second registration method.

4. The computer-implemented method of claim 1, further comprising:
generating a registration quality index; and
using reinforcement learning to choose the second registration method.

5. The computer-implemented method of claim 4, wherein determining the second registration method comprises comparing the first registration method to the second registration method based on the reward score and the feature vector.

6. The computer-implemented method of claim 1, further comprising:
changing registration configuration data based on rules until a completion criterion is met, wherein the completion criterion is either that a successful alignment is reached, or an attempt threshold is reached.

7. The computer-implemented method of claim 1, wherein the changing registration configuration data is selected from a group consisting of a cost function, an optimization method, an initial transformation, a multi-resolution registration, a registration mask, and a hyper-parameter.

8. A computer program product comprising:
one or more computer readable storage media, and program instructions collectively stored on the one or more computer readable storage media, the program instructions comprising:
program instructions to evaluate alignment of a registered image and a fixed image using a pre-trained learning model, the registered image generated with a first registration method;
program instructions to provide a reward score to the alignment, the reward score being defined as a higher score indicating a better alignment;
program instructions to generate a registration status represented as a feature vector that contains information about how the registered and fixed images are aligned; and
program instructions to determine a second registration method based on the reward score, the feature vector, and the first registration method.

9. The computer program product of claim 8, further comprising:
program instructions to combine the registered image and the fixed image into an RGB image.

10. The computer program product of claim 8, further comprising:
program instructions to classify the registered image and the fixed image into being misaligned; and
program instructions to use reinforcement learning to choose the second registration method.

11. The computer program product of claim 8, further comprising:
program instructions to generate a registration quality index; and
program instructions to use reinforcement learning to choose the second registration method.

12. The computer program product of claim 11, wherein program instructions to determine the second registration method comprise program instructions to compare the first registration method to the second registration method based on the reward score and the feature vector.

13. The computer program product of claim 8, further comprising:
program instructions to change registration configuration data based on rules until a completion criterion is met, wherein the completion criterion is either that a successful alignment is reached, or an attempt threshold is reached.

14. The computer program product of claim 8, wherein the changing registration configuration data is selected from a group consisting of a cost function, an optimization method, an initial transformation, a multi-resolution registration, a registration mask, and a hyper-parameter.

15. A computer system comprising:
one or more computer processors, one or more computer readable storage media, and program instructions stored on the one or more computer readable storage media for execution by at least one of the one or more computer processors, the program instructions comprising:
program instructions to evaluate alignment of a registered image and a fixed image using a pre-trained learning model, the registered image generated with a first registration method;
program instructions to provide a reward score to the alignment, the reward score being defined as a higher score indicating a better alignment;
program instructions to generate a registration status represented as a feature vector that contains information about how the registered and fixed images are aligned; and
program instructions to determine a second registration method based on the reward score, the feature vector, and the first registration method.

16. The computer system of claim 15, further comprising:
program instructions to combine the registered image and the fixed image into an RGB image.

17. The computer system of claim 15, further comprising:
program instructions to classify the registered image and the fixed image into being misaligned; and
program instructions to use reinforcement learning to choose the second registration method.

18. The computer system of claim 15, further comprising:
program instructions to generate a registration quality index; and
program instructions to use reinforcement learning to choose the second registration method.

19. The computer system of claim 18, wherein program instructions to determine the second registration method comprise program instructions to compare the first registration method to the second registration method based on the reward score and the feature vector.

20. The computer system of claim 15, further comprising:
program instructions to change registration configuration data based on rules until a completion criterion is met, wherein the completion criterion is either that a successful alignment is reached, or an attempt threshold is reached.
